(19) United States
(12) Patent Application Publication
(10) Pub. No.: US 2017/0350343 A1
(43) Pub. Date: Dec. 7, 2017

(54) PISTON FOR INTERNAL COMBUSTION ENGINE, AND PROCESS AND DEVICE FOR PRODUCING SAID PISTON

(71) Applicant: HITACHI AUTOMOTIVE SYSTEMS, LTD., Hitachinaka-shi, Ibaraki (JP)

(72) Inventor: Masato SASAKI, Sagamihara-shi, Kanagawa (JP)

(73) Assignee: HITACHI AUTOMOTIVE SYSTEMS, LTD., Hitachinaka-shi, Ibaraki (JP)

(21) Appl. No.: 15/536,808

(22) PCT Filed: Oct. 13, 2015
(86) PCT No.: PCT/JP2015/078864

§ 371 Date: Jun. 16, 2017

(30) Foreign Application Priority Data
Dec. 25, 2014 (JP) 2014-261720

(51) Int. Cl. F02F 3/00; B22C 9/10

(52) U.S. Cl. CPC F02F 3/0084; B22C 9/108; F02F 2200/00

(57) ABSTRACT

This piston includes a low thermal conductivity part comprising: a porous member made of a borosilicate glass that has a lower thermal conductivity than the piston base material made of an aluminum alloy material that is the base material impregnated into the porous member. A molded object obtained from a first powder (glass powder) and a second powder (sodium chloride powder) is put in hot water to dissolve away the second powder and form pores in the porous member. The aluminum alloy material is impregnated into these pores to unite the porous member to the piston base material. Furthermore, varnish containing polyimide, etc. is applied to the upper surface of the porous member and impregnated into the pores with a varnish impregnation device assisted by vacuum drawing and atmospheric pressure, thereby preventing the pores from remaining vacant. Due to this, deterioration in exhaust emission performance can be prevented.

### TECHNICAL FIELD

The present invention relates to an internal combustion engine piston formed by casting, and a process and device for producing the internal combustion engine piston.

### BACKGROUND ART

As is well known, as a spark-ignition gasoline internal combustion engine, a so-called direct-injection (GDI) internal combustion engine is provided, which is aimed to improve fuel economy by lean burn and enhance output power by homogeneous combustion.

In such an engine, it is known that provision of a thermal insulating material partly in a crown surface of a piston made of aluminum alloy, wherein the crown surface forms a combustion chamber, produces an effect to promote atomization of injected fuel. However, it is difficult to tightly bind the thermal insulating material to the aluminum alloy base material.

Therefore, as described in following patent document 1 for which the applicant applied above, a low thermal conductivity part which is lower in thermal conductivity than the aluminum alloy base material is provided at a predetermined location of the crown surface of the piston. The low thermal conductivity part has a structure where a porous member made of a glass material lower in thermal conductivity than the aluminum alloy base material is impregnated with aluminum alloy material which is a piston base material. According to the structure, both high thermal insulation performance and high bonding strength between the piston base material and the low thermal conductivity part are satisfied.

### PRIOR ART DOCUMENT

### Patent Document

Patent Document 1: Japanese Patent Application Publication No. 2014-25418

### SUMMARY OF THE INVENTION

However, in the prior art described in Patent Document 1, the aluminum alloy molten metal is not sufficiently impregnated into the whole of each pore of the porous thermal insulting material due to viscosity, etc. of the aluminum alloy molten metal. Thereby, not a few vacant pores remain.

Therefore, in a driving of the internal combustion engine, unburnt gas gets into the remaining pores and is discharged as it is as exhaust gas, so there is a risk of deteriorating exhaust emission performance.

It is an object of the present invention to provide a piston for internal combustion engine to be able to prevent vacant pores of a porous member from remaining by improving sealing treatment and to prevent deterioration of exhaust emission performance, while securing high thermal insulation performance and high bonding strength in a piston base material by a low thermal conductivity part.

In particular, the invention described in claim 1 is characterized in that the low thermal conductivity part comprises a porous member having thermal conductivity lower than that of the piston base material and an impregnant with which pores of the porous member is impregnated, wherein the impregnant is held in the pores under usage environment of the piston during the driving of the engine.

According to the present invention, it is possible to prevent the pores of the porous member from remaining by improving the sealing treatment to prevent the deterioration of the exhaust emission performance.

### BRIEF DESCRIPTION OF THE DRAWINGS

FIG. 1A is a longitudinal sectional view of an internal combustion engine piston according to the present invention. FIG. 1B is an enlarged view of an A-part shown in FIG. 1A.

FIG. 2A is a longitudinal sectional view of a porous member employed in the present embodiment. FIG. 2B is an enlarged view of a B-part shown in FIG. 2A.

FIG. 3 is a characteristic diagram showing vacant pores (porosity) and residual sodium chloride in relation to a volume ratio of sodium chloride in the porous member.

FIG. 4 is a characteristic diagram showing a relationship between volume of sodium chloride and thermal conductivity.

FIG. 5 is a longitudinal sectional view showing a casting mold device employed in the present embodiment.

FIG. 6 is a longitudinal sectional view showing a piston shaped body immediately after being cast by the casting mold device.

FIG. 7 is a schematic view showing a varnish impregnation device employed in the present embodiment.

FIG. 8 is a schematic view of a varnish impregnation step by the varnish impregnation device, wherein FIG. 8A shows a situation where varnish is provided into a vacuum vessel under a vacuum state, FIG. 8B shows a situation where to provide the varnish has finished, and FIG. 8C shows a situation where the varnish has been impregnated into each of pores.

FIG. 9 shows a schematic view showing a varnish impregnation device employed in the second embodiment, wherein FIG. 9A shows a situation where a negative pressure introduction mechanism and a varnish providing mechanism are not connected with the vacuum vessel, and FIG. 9B shows a situation where these mechanisms are connected with the vacuum vessel.

FIG. 10 is a schematic view of a varnish impregnation device employed in the present embodiment.

### MODE(S) FOR CARRYING OUT THE INVENTION

The following describes in detail an internal combustion engine piston according to the present invention, and a process and device for producing the internal combustion engine piston according to the present embodiments, with reference to the drawings. The piston employed in the present embodiments is applied to a spark-ignition direct-injection gasoline engine.

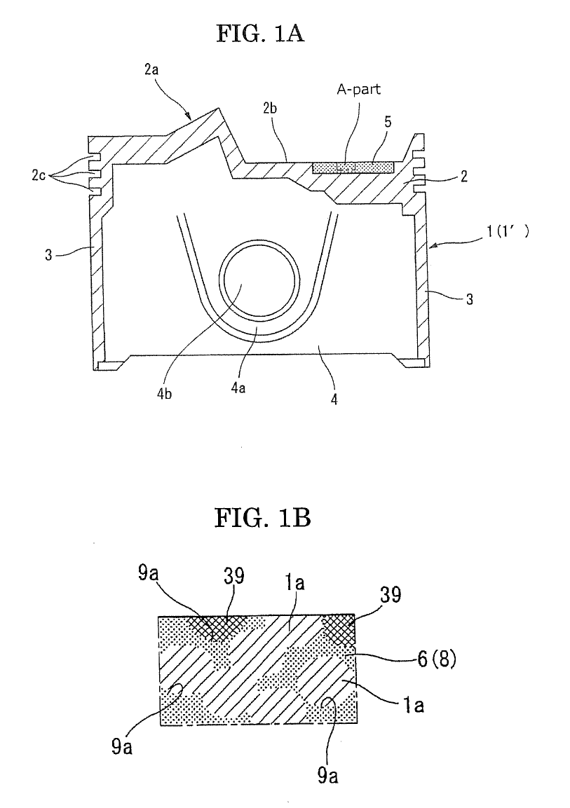

The whole of the piston 1 is integrally cast of an AC8A Al—Si based aluminum alloy as a base material. As shown in FIG. 1A, the piston 1 includes: a crown part 2 formed into a substantially cylindrical shape, and defining a combustion chamber by a crown surface 2a; a thrust-side skirt part 3 and an anti-thrust-side skirt part 3 in a pair, each of which is integrally formed with an outer peripheral edge of a lower end of the crown part 2, and has a circular arc shape; and a pair of apron parts 4 coupled to both ends of each skirt part 3 in its circumferential direction. The apron parts 4 are integrally formed with respective pin boss portions 4a, 4a for supporting both ends of a piston pin (not shown). The pin boss portions 4a, 4a include pin holes 4b, 4b.

The crown part 2 has a disc shape formed relatively thick. The crown surface 2a defining the combustion chamber is formed in a substantially uneven shape in a cross section, and is formed partly with a recessed portion 2b having a large flat surface area. A low thermal conductivity part 5 lower in thermal conductivity than a piston base material 1′ is embedded in a predetermined location of an upper surface of the recessed portion 2b. Further, the outer periphery of the crown part 2 is formed with three piston ring grooves 2c.

The low thermal conductivity part 5 is embedded in the location of the recessed portion 2b receiving direct injection of fuel from an injector in the form of a fuel injection valve provided in a cylinder head (not shown). The low thermal conductivity part 5 is integrally embedded in the recessed portion 2b during casting of the piston 1 described below. As shown in FIG. 1B, in the low thermal conductivity part 5, a part of aluminum alloy material 1a of the piston base material 1′ is impregnated into the inside of a porous member 6 which is made of a glass material having lower thermal conductivity than the piston base material 1′.

That is, the low thermal conductivity part 5 is composed of the porous member 6, the aluminum alloy material 1a, and varnish 39. The porous member 6 is basically formed in a protrusive disk shape by a production process described later separately from the piston 1 and formed of the glass material. The aluminum alloy material 1a is a part of the piston base material 1′ which is impregnated into pores 9a after water-soluble salt of the porous member 6 impregnated in advance has been dissolved. The varnish 39 is impregnated into the pores 9a, and it is described later.

### <Production Process for Porous Member>

The following describes the outline of the production process for the porous member 6. First, a first powder 8 and a second powder 9 are mixed together to produce a mixed powder, wherein the first powder 8 is a powder of glass insoluble in water, and the second powder is a soluble powder (sodium chloride powder). The mixed powder is placed into a mold, and pressure-formed at a predetermined pressure, and thereafter sintered at a predetermined sintering temperature TB. The sintering temperature TB is lower than the sintering temperature TA of the second powder 9.

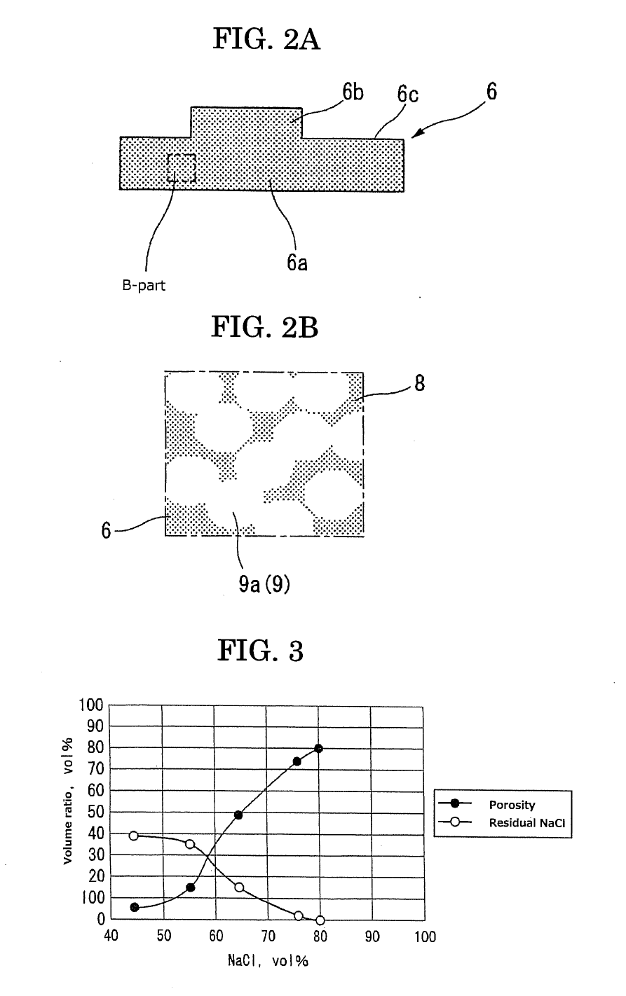

Thereafter, the sintered product is immersed in water or hot water that has been stirred, so that the second powder 9 in the sintered product is dissolved away by the water or hot water, to form many pores 9a and thereby form the porous member 6 shown in FIG. 2. The thermal conductivity of the porous member 6 is sufficiently lower than that of the base material 1′ that is a molten metal.

The first powder 8 is a glass powder as described above, and is a hard and transparent substance based on silicate, borate, phosphate which is a non-crystalline solid exhibiting a glass transition phenomenon with rising temperature. Chemically, the first powder 8 mainly contains a silicate compound (silicate mineral) which becomes glassy state. The oxide constituting the glass is SiO₂, Al₂O₃, B₂O₃, BaO, Bi₂O₃, Li₂O, MgO, P₂O₅, PbO, SnO, TiO₂, ZnO, R₂O (R is an abbreviation of alkali metal: Li, Na, K), or RO (R is an abbreviation of alkaline-earth metal: Mg, Ca, Sr, Ba).

The temperature at which the first powder 8 is softened (softening point) is lower than the melting point of the second powder 9, wherein the first powder 8 has a melting point higher than or equal to 700° C.

The glass transition point, which is a temperature at which the glass structure changes, wherein the viscosity is about 1013.3 poise. The softening point, which is a temperature at which the glass is softened and deformed by its own weight, wherein the viscosity is about 107.6 poise.

On the other hand, the second powder 9 contains a water-soluble salt such as sodium chloride, potassium chloride, magnesium chloride, calcium chloride, calcium carbonate, sodium carbonate, sodium sulfate, magnesium sulfate, potassium sulfate, sodium nitrate, calcium nitrate, magnesium nitrate, potassium nitrate, or sodium tetraborate. The second powder 9 may be one of them or a mixed salt of two or more of them.

It is desirable that the salt is a water-soluble salt having a melting point exceeding 700° C., such as sodium chloride, potassium chloride, magnesium chloride, calcium chloride, calcium carbonate, sodium carbonate, sodium sulfate, magnesium sulfate, potassium sulfate, or sodium tetraborate. In the present embodiment, sodium chloride is employed.

### Example

The following describes a specific process for producing the porous member 6.

First, the first powder 8 is mixed with the second powder 9 while stirred, wherein the first powder 8 is borosilicate glass (glass powder ASF1898, produced by Asahi Glass Co., Ltd.), and the second powder 9 is sodium chloride.

The mixing ratio of the first powder 8 and the second powder 9 was set so that the first powder was 40 to 20 vol % and the second powder 9 was 60 to 80 vol %. The first powder 8 and the second powder 9 were mixed to produce a mixed powder, wherein the first powder 8 and the second powder 9 were in a weight ratio of 54:46 (mixing step).

The particle size of each powder was set so that the first powder 8 had an average particle size of 4.5 μm, and the second powder 9 had a particle size where 75 to 180 μm was 70% or more.

Then, the mixed powder was set in a mold and pressure-formed, and burnt by heating at a temperature of 650 to 750° C. for a period of 20 to 40 minutes. In this example, the mixed powder was heated at a temperature of 700° C. for a period of 30 minutes, to obtain a sintered product (burning step).

The sintered product was immersed in stirred hot water (liquid) at 55° C. so that the inside second powder 9 (sodium chloride) was dissolved and extracted from the sintered product to obtain a porous member 6 having many pores 9a (dissolving step). In the dissolving step, the second powder 9 is subjected to dissolution in hot water at 50 to 95° C. for a period of 30 minutes to 3 hours.

As shown in FIG. 2A, the porous member 6 includes a disk-shaped base portion 6a, and a projecting portion 6b, wherein the projecting portion 6b has a small-diameter cylindrical shape, and is integrally formed with the upper surface of the base portion 6a. Further, as shown in FIG. 2B, major part of the second powder 9 is dissolved and removed from the porous member 6, and the first powder 8 (glass) remains in the porous member 6, so that many pores 9a are formed around the first powder 8.

In the mixing step and the burning step described above, heating the molded body of the mixed powder of the first powder 8 (glass powder) and the second powder 9 (sodium chloride) causes the glass powder to surround and cover the particles of sodium chloride. Accordingly, the formed configuration of the porous member 6 varies depending on the mixing ratio of the first powder 8 and the second powder 9.

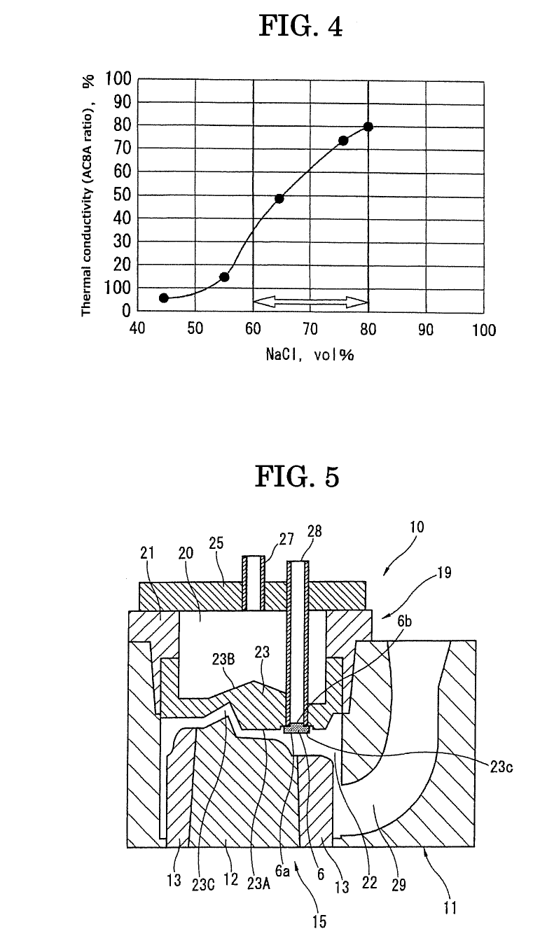

That is, the inventor(s) of the present application made an experiment in which the mixing ratio of the first powder 8 and the second powder 9 was variously changed, and got a result shown in FIGS. 3 and 4.

Specifically, for example, when the powder of sodium chloride is at 80 vol % or more, and the glass powder is at 20 vol % or less, the glass powder particles are not melt-bonded to each other by heating. Therefore, a molded body can be produced, so that the form of the body is lost when dissolved in water or hot water.

When the powder of sodium chloride is less than 60 vol %, and the glass powder is more than 40 vol %, the glass powder particles are melt-bonded to each other easily by heating, resulting in surrounding and covering the sodium chloride powder particles. Accordingly, when the powder of sodium chloride is dissolved out in water or hot water thereafter, the water or hot water cannot contact the sodium chloride powder, so that the porous member 6 cannot be formed.

When the powder of sodium chloride is at 60 to 80 vol %, and the glass powder is at 40 to 20 vol %, open pores 9a (pores communicating from the surface to the inside) are obtained. All of the sodium chloride powder is not dissolved, but part of the sodium chloride powder is brought into closed state by being covered with the glass powder. The quantity of sodium chloride powder in the closed state is determined by the mixing ratio of the sodium chloride powder (second powder 9) and the glass powder (first powder 8).

When the sodium chloride (second powder 9) is at 80 vol %, there is no residual sodium chloride after the dissolution. As the volume percent of the second powder 9 decreases, the volume percent of the residual sodium chloride increases. Then, when the second powder 9 is at 60 vol %, the residual sodium chloride powder is at 25 vol %. The residual sodium chloride powder is surrounded by the first powder 8 that is a glass powder, and functions as a thermal insulating material. On the other hand, when the porous material 6 thus obtained is impregnated with a piston cast alloy (a part of aluminum alloy material 1a) described below, and the impregnated part is finished by cutting, the residual sodium chloride appears in the cut surface.

When the appeared sodium chloride powder is dissolved and removed with water or hot water again, the cut surface becomes a composite structure of cast alloy of the piston base material 1′ and the glass that is the porous member 6. As the quantity of the sodium chloride powder increases, the dissolved quantity increases, which increases the unevenness of the surface and thereby increases the area of the surface.

In view of the foregoing, in this embodiment, the second powder 9 (sodium chloride powder) was set at 60 to 80 vol %, and the first powder 8 (glass powder) was set at 40 to 20 vol %.

Next, most of the second powder 9 is removed, and the porous member 6 composed mainly of the first powder 8 (glass) is placed in a vacuum casting mold 10 described later, thereafter, the molten metal of aluminum alloy is injected into the mold 10 to mold the piston 1. In addition, part of the molten metal of the base material 1′ is impregnated into each pore 9a of the porous member 6 during the molding of the piston 1, to embed the low thermal conductivity part 5 integrally in the recessed portion 2b of the crown surface 2a (injection step).

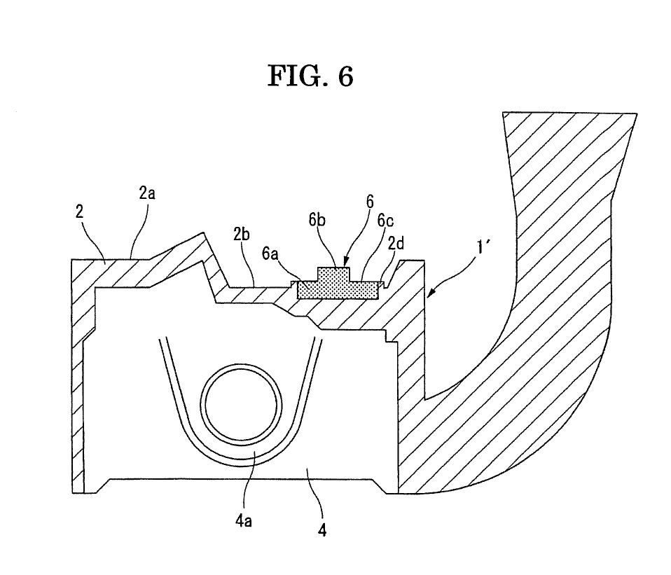

The vacuum casting mold 10 is briefly explained, as it is identical to the one described in Japanese Patent Application Publication No. 2014-25418, which is cited as the prior art. As shown in FIG. 5, a mold 11 includes a core 15 in a lower part of the mold 11 wherein the core 15 is formed as a combination of a plurality of split cores, such as a center core 12, and a Philip core 13 and a side core arranged around the center core 12. Furthermore, the vacuum casting mold 10 is provided with left and right wrist pins (not shown) extending horizontally and facing each other for forming a cooling passage for circulating cooling water therein. The distal end of the wrist pin is detachably engaged with a hole formed in the side core.

The vacuum casting mold 10 further includes a top core 19 in the upper part, which is removable from the mold 11. The top core 19 includes an outer top core 21 and an inner top core 23, wherein the outer top core 21 has a space as an example of a vacuum vent section 20, and the inner top core 23 is integrally provided with the outer top core 21.

The outer top core 21 is provided with an adapter 25 in the upper end part for sealing the vacuum vent section 20, and is provided with a first communication pipe 27 substantially in the center of the adapter 25. The first communication pipe 27 communicates with the vacuum vent section 20, and is connected to a negative pressure generator such as a vacuum pump (not shown). Accordingly, the inside of the vacuum vent section 20 can be depressurized to a negative pressure by operation of the negative pressure generator.

The inner top core 23 is for forming a cavity 22 between the core 15 and the mold 11, and is formed as an air-permeable mold (porous mold) made of a porous material.

A cavity surface 23A, which is a lower surface of the inner top core 23, is formed as a transfer surface for transferring the crown surface 2a of the piston 1 and formed as a finished surface by electrical discharge machining. Accordingly, the inner top core 23 is excellent in heat resistance and wear resistance to a molten aluminum alloy, and no galling occurs.

Moreover, in the cavity surface 23A of the inner top core 23, a part 23B is formed to have a thickness greater than 2 mm and less or equal to 12 mm, wherein the part 23B corresponds to a delicate portion and an edge portion of a crown combustion chamber of the crown surface 2a of the piston 1 as a product.

As shown in FIG. 5, the predetermined location of the inner top core 23 is provided with a second communication pipe 28 which is a metal pipe, and extends in the vertical direction through the inner top core 23, the vacuum vent section 20, and the adapter 25. The lower end portion of the second communication pipe 28 is formed with a retaining recess 23c for retaining the porous member 6. Namely, the porous member 6 is retained in the predetermined location in the cavity surface 23A of the inner top core 23 in advance, and the projecting portion 6b is fitted and retained by press-fitting in the lower end portion of the second communication pipe 28, and the base portion 6a is retained in contact with the peripheral surface of the retaining recess 23c.

The upper end portion of the second communication pipe 28 is connected to a negative pressure generator such as a vacuum pump (not shown), similar to the first communication pipe 27. Accordingly, by operation of the negative pressure generator, the inside of the porous member 6 retained in the retaining recess 23c in advance is depressurized to a negative pressure, so that molten metal of the aluminum alloy 1a described below is impregnated into the many pores 9a.

Therefore, when the vacuum vent section 20 is brought into a negative pressure state, gas in the cavity 22 is sucked through the inner top core 23 to the vacuum vent section 20 and then vented to the outside. Furthermore, the molten aluminum alloy injected into the cavity 22 is sucked into direct contact with the cavity surface 23A (transfer surface) of the inner top core 23, so that the shape of the cavity surface 23A is transferred as it is.

In addition, when the vacuum vent section 20 is brought into the negative pressure state to suck and vent the gas in the cavity 22, and the molten metal in the cavity 22 is sucked into direct contact with the cavity surface 23A of the inner top core 23, it is possible to effectively carry out the suction of the part corresponding to the delicate portion or edge portion of the product, and thereby transfer the shape of the cavity surface 23A of the inner top core 23 accurately, even if the product includes the delicate portion or edge portion.

The mold 11 is further provided with a runner 29 for injecting the molten metal into the cavity 22, wherein the runner 29 is communicated with the lower portion of the cavity 22.

### <Casting Process of Piston>

Accordingly, in order to cast the piston 1 with the mold 10, the molten metal of aluminum alloy is injected into the cavity 22 through the runner 29 of the mold 11 (injecting step), and the vacuum vent section 20 is subjected to the negative pressure. The provision of the molten metal into the cavity 22 is performed at the lower side of the cavity 22, and the vacuum vent section 20 is depressurized to the negative pressure, so that the gas in the cavity 22 passes through the inner top core 23, and is vented to the outside.

Simultaneously, the porous member 6 is depressurized to the negative pressure through the second communication pipe 28 by the vacuum pump, so the molten metal supplied to the cavity 22 is sucked into direct and intimate contact with the cavity surface 23A (transfer surface) of the inner top core 23, because the vacuum vent section 20 is at negative pressure.

Specifically, when the molten metal of aluminum alloy is injected into the cavity 22 through the runner 29, and the sprue is closed by the molten metal of aluminum alloy, a motor for depressurization (not shown) is driven to vent air from the vacuum vent section 20, and thereby depressurize the vacuum vent section 20. When this depressurization causes a differential pressure between the vacuum vent section 20 and the cavity 22, the gas in the cavity 22 is vented through the pores of the inner top core 23, which is a breathable mold (porous mold), to the outside.

When the molten metal in the cavity 22 rises gradually to be into contact with the cavity surface 23A of the inner top core 23, the molten metal is sucked into intimate contact with the cavity surface 23A because the vacuum vent section 20 is depressurized. When the piston 1 is formed, the unevenness of the cavity surface 23A is transferred to the piston crown surface. The configuration that the part 23B of the recessed portion 23C of the cavity surface 23A, which corresponds to the projecting part of the piston crown surface, is formed thinner than the remaining part, makes it possible to effectively perform the suction and intimate contact of the molten metal at this part, and precisely form a part of the crown surface 2a even if the shape of the part of the crown surface 2a is hard to appear.

Since the inside of the porous member 6 is at negative pressure, part of the molten metal of aluminum in the cavity 22 is sucked into the porous member 6, and is made to permeate and fill the many pores 9a from which sodium chloride has been dissolved. As a result, as shown in FIG. 6, the low thermal conductivity part 5 impregnated with the aluminum alloy material 1a that is the piston base material 1′ is embedded integrally in and fixed to the piston base material 1′. The pores 9a are impregnated with the aluminum alloy material 1a, wherein a small quantity of the second powder 9 (sodium chloride) remains.

Thereafter, the piston base material 1′, which is integrated with the low thermal conductivity part 5, is taken out from the cooled vacuum casting mold 10. In an upper surface of the recessed portion 2b of the piston base material 1′, a cylindrical part 2d is integrally formed on the outer peripheral side of the low thermal conductivity part 5 and formed so that the height of the cylindrical part 2d is an approximately same height as height of the low thermal conductivity.

Thereafter, a varnish 39 is impregnated into the pores 9a of an upper surface of the low thermal conductivity part 5 (porous member 6) of the piston base material 1′ by a varnish impregnation device.

That is, as a lot of pores 9a (1-10% of all porosity) are generated on, especially, an upper surface 6c of the porous member 6, there is a risk of deteriorating exhaust emission performance due to fuel gas generated in a lot of pores 9a, as mentioned above. Therefore, a sealing treatment is conducted. As a general sealing treatment, an organic sealing agent is infiltrated and impregnated into the pores 9a. As major types of the sealing agent, it is possible to cite epoxy resin, phenolic resin, vinyl resin, butyral resin, derivative of organic amine, etc. As a sealing agent (impregnant), one having low viscocity to be capable of easily impregnating into the pores is desirable, and used in means such as brush coating, dip coating, and spray coating.

However, in these sealing agents, their heat resisting temperatures are low, so they cannot endure a thermal environment where the temperature of the crown surface of the piston 1 is 350° C. In the impregnation into the pores 9a, sufficient impregnation into the pores 9a can't be expected from the brush coating, etc. Furthermore, it is possible to impregnate it into gaps of several μm by applying, that is to say, a vacuum impregnation method. However, as the whole components are impregnated in a general vacuum impregnation method, it is necessary to clean other part than impregnated part after the treatment. Therefore, it is poor in workability.

So, in the present embodiments, an impregnating property of the varnish 39 into each of pores 9a has been improved by the following varnish impregnation device which is vacuum-assisted.

The varnish 39 must be what can endure combustion heat of an injection fuel after curing as a sealing agent. In the present embodiments, it is polyimide precursor or polyamide imide precursor, which has a glass transition temperature of 350° C. or higher, and it is solved in a solvent mainly including DMA, DMF, or GBL. This has been selected from the following Tables 1 and 2 which are based on the results of experiments by the inventor(s) of the present application. In addition, as to the varnish 39, a polyimide solution having already formed into polyimide can be used, not a precursor.

In the experiments, two types (1) and (2) of polyimide (PI) and two types (1) and (2) of polyamide imide (PAI) are respectively prepared as the varnishes 39, and the above solvents are added to them and dissolved. Furthermore, these are provided into the pores 9a of the porous member 6 by the above mentioned device. In the state, the experiments has been conducted.

First, in Table 1, in order to volatilize the solvent of the varnish, they have been heated under atmosphere at 100 to 200° C. for 30 minutes and for 60 minutes. One where the solvent wasn't volatilized by curing the surface of the varnish and the surface swelled was regarded as x, and one where there were no change in the surface was regarded as ∘.

Next, in Table 2, continuously one having regarded as ∘ was heated under atmosphere at 300° C. for 30 minutes. One which swelled by volatilization of residual solvent or which was carbonized by thermal decomposition was regarded as x, and one which remained as a solid matter with small volume change was regarded as ∘.

TABLE 1
Solvant Volatilization

| | | min | 100 | 110 | 120 | 130 | 140 | 150 | 160 | 170 | 180 | 190 | 200 |
|---|---|---|---|---|---|---|---|---|---|---|---|---|---|
| PI | (1) | 30 | ∘ | ∘ | ∘ | ∘ | ∘ | ∘ | x | x | x | x | x |
| | (2) | 60 | ∘ | ∘ | ∘ | ∘ | ∘ | ∘ | x | x | x | x | x |
| PAI | (1) | 30 | ∘ | ∘ | ∘ | ∘ | ∘ | ∘ | x | x | x | x | x |
| | (2) | 60 | ∘ | ∘ | ∘ | ∘ | ∘ | ∘ | x | x | x | x | x |

TABLE 2
Heating under atmosphere 300° C. × 30 min

| | | min | 100 | 110 | 120 | 130 | 140 | 150 | 160 | 170 | 180 | 190 | 200 |
|---|---|---|---|---|---|---|---|---|---|---|---|---|---|
| PI | (1) | 30 | x | x | ∘ | ∘ | ∘ | ∘ | | | | | |
| | (2) | 60 | x | ∘ | ∘ | ∘ | ∘ | ∘ | | | | | |
| PAI | (1) | 30 | x | x | x | x | ∘ | ∘ | | | | | |
| | (2) | 60 | x | x | x | ∘ | ∘ | ∘ | | | | | |

According to Table 1, in both of (1), (2) in PI and PAI, regarding heating in the range of 100 to 150° C. for 30 to 60 minutes, there were no change in the surface of varnish, so they were regarded as ∘. However, in higher than 150° C., the solvent wasn't volatilized by curing the surface of varnish, and the surface swelled, so they were regarded as x.

Thereafter, in case of heating the varnishes regarded as ∘ in Table 1 under atmosphere at 300° C. for 30 minutes, as shown in Table 2, one heated at low temperatures such as 100 to 110° C. in (1) and (2) of PI, one heated at 100 to 130° C. in (1) of PAI, and one heated at low temperatures such as 100 to 120° C. in (2) were not available, because swelling, which is caused by the residual solvents, occurred by heating under atmosphere at 300° C.

On the other hand, as to one heated at relatively high temperatures such as 130 to 150° C. in Table 1, the varnish 39 impregnated into each of pores 9a didn't change largely even if they were further heated under atmosphere at 300° C. Therefore, it was found that sufficient impregnating effects can be obtained.

Accordingly, judging from this experiment results, it has been found that the varnish 39 heated at 130 to 150° C. for 30 to 60 minutes is especially suitable. That is, the varnish 39 obtained in the temperature condition and the heating time condition is excellent in terms of heat-resisting property and durability.

### [Varnish Impregnation Device]

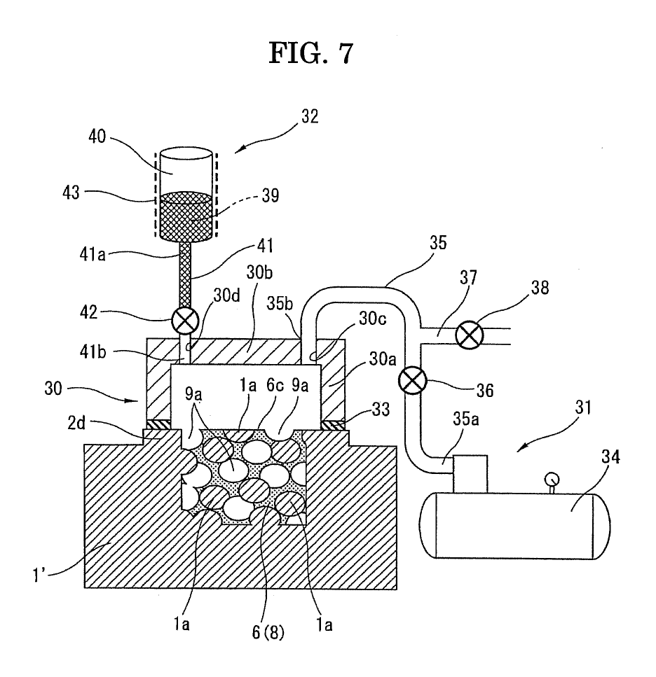

As shown FIG. 7, the varnish impregnation device is composed of a vacuum vessel 30; a negative pressure introduction mechanism 31; and a varnish providing mechanism 32. The vacuum vessel 30 is mounted and held on an upper end face of the cylindrical part 2d formed on the recessed portion 2b of the piston base material 1′, and is a cup shaped member having a cylindrical shape with a cover. The negative pressure introduction mechanism 31 makes the inside of the vacuum vessel 30 be in a negative pressure condition. The varnish providing mechanism 32 provides varnish for an outside surface of the low thermal conductivity part 5.

The vacuum vessel 30 is integrally formed of stainless steel based metal material which has a relative thick wall and high rigidity and arranged so as to cover an upper surface of the low thermal conductivity part 5. Furthermore, the vacuum vessel 30 is mainly composed of a cylindrical wall 30a mounted on the upper surface of the cylindrical part 2d; and an upper wall part 30b which is disk-shaped and integrally formed on an upper end part of the cylindrical wall 30a.

The cylindrical wall 30a is formed so that its outer diameter is fractionally smaller than that of the cylindrical part 2d and so that its inner diameter is larger than that of the cylindrical part 2d. Furthermore, the cylindrical wall 30a is mounted and held on the upper surface of the cylindrical part 2d. In addition, in the entire underside, annular sealing material 33 which seals a gap between the cylindrical wall 30a and the upper surface of the cylindrical part 2d is integrally provided.

Regarding the upper wall part 30b, a first fixing hole 30c where a vacuum pipe 35 of the negative pressure introduction mechanism 31 is inserted and fixed is penetratingly formed at a predetermined location in the outer circumferential side of the upper wall part 30b. Furthermore, a second fixing hole 30d where a varnish providing pipe 41 of the varnish providing mechanism 32 is inserted and fixed is penetratingly formed at a location opposite to the fixing hole 30c in a radial direction.

The negative pressure introduction mechanism 31 is mainly composed of a vacuum pump 34; a vacuum pipe 35; a first switching valve 36; and a third switching valve 38. The vacuum pump 34 is a negative pressure generator which generates negative pressure. The vacuum pipe 35 is a negative pressure introduction passage wherein its one end part 35a is connected with the vacuum pump 34 and its other end part 35b is connected with the vacuum vessel 30 through the fixing hole 30c. The first switching valve 36 is disposed on the way of the vacuum pipe 35, and it communicates with or block the inside of the vacuum pipe 35. The third switching valve 38 is disposed in an atmospheric pressure introduction pipe 37 which diverges from a downstream side of the first switching valve 36 and communicates with atmosphere.

The vacuum pump 34 is general one using oil, etc. and creates a vacuum condition by sucking the inside of the vacuum vessel 30 at a predetermined suction pressure.

The first switching valve 36 is conducted to opening/closing operation during the following impregnation work of varnish. It is opened during operating the vacuum pump 34 and, it is closed when the operation stops. Furthermore, after the closing operation, the third switching valve 38 is conducted to the opening operation.

The varnish providing mechanism 32 is mainly composed of a storage tank 40; a varnish providing pipe 41; and a second switching valve 42. The storage tank 40 is bottomed cylindrical shaped and stores the varnish 39, which is an impregnant, therein. The varnish providing pipe 41 is an impregnant introduction passage wherein its one end part 41a is connected with the storage tank 40 and its other end part 41b is connected with the second fixing hole 30d of the vacuum vessel 30. The second switching valve 42 is disposed on the way of the varnish providing pipe 41.

The storage tank 40 has a heater 43 in the entire periphery. This heater 43 holds temperature of the varnish 39 at a fixed value in order to stabilize the viscosity of the internal varnish 39.

The second switching valve 42 is what opens and closes the varnish providing pipe 41 during the following varnish filling (providing) operation. When the pressure of the vacuum vessel 30 is reduced by the predetermined pressure by the vacuum pump 34, it performs opening operation to provide the varnish 39 being in the storage tank 40 for a side of an upper surface 6c of the porous member 6.

Furthermore, the negative pressure introduction mechanism 31 and the varnish providing mechanism 32 are in a state that they are connected with the vacuum vessel 30 in advance.

Hereinafter, operation process of impregnating the varnish 39 into each of pores 9a of the porous member 6 is explained.

First, as shown in FIG. 7, through the sealing member 33, the vacuum vessel 30 is mounted and fixed on the upper surface of the cylindrical part 2d which is on the crown part 2 of the piston base material 1′ molded by the producing process mentioned above.

Thereafter, the other end part 35b of the vacuum pipe 35 of the vacuum pump 34 is connected with and fixed on the first fixing hole 30c, and a lower end part of the varnish providing pipe 41 where the storage tank 40 is installed is connected with the second fixing hole 30d.

At this time, all of the switching valves (the first switching valve 36, the second switching valve 42, the third switching valve 38) are in a state of closing operation. Therefore, a communication of upstream and downstream with regard to each of the vacuum pipe 35 and varnish providing pipe 41 is blocked, and a communication between the inside of the vacuum pipe 35 and atmosphere is also blocked.

Next, a predetermined amount of the varnish 39 is put into the storage tank 40, and the varnish 39 in the storage tank 40 is heated by the predetermined temperature while turning on the switch of the heater 43 in order to stabilize the viscosity of the varnish 39.

Thereafter, the first switching valve 36 is opened, and the vacuum pump 34 is operated. When the pressure in the vacuum vessel 30 becomes 0.01 MPa or less in a degree of vacuum, the first switching valve 36 is closed.

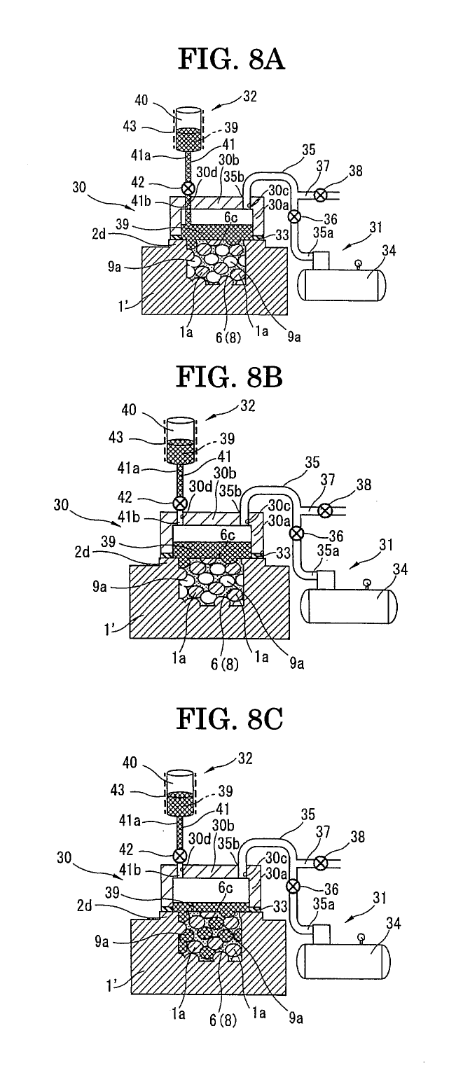

Thereafter, as shown in FIG. 8A and FIG. 8B, the varnish providing pipe 41 is communicated with the vacuum vessel 30 by opening the second valve 42, and the varnish 39 is supplied into the vacuum vessel 30. Thereby, the upper surface 6c of the porous member 6 is made into a state of being covered with the varnish 39. Thereafter, the second switching valve is closed after the provision volume of the varnish 39 had gotten proper. Thereby, the upper surface 6c of the porous member 6 gets the state of being covered with the varnish 39.

Subsequently, as shown in FIG. 8C, the third valve 38 is conducted to the opening operation in the state where the first switching valve 36 remains to close. Thereby, atmospheric pressure is supplied into the vacuum vessel 30 through the downstream side of the vacuum pipe 35 from the atmospheric pressure introduction pipe 37. Thereby, the varnish 39 is impregnated into each of pores 9a, which is in vacuum condition, in a state the varnish 39 is strongly sucked by the atmospheric pressure.

After the varnish 39 has been impregnated into each of pores 9a of the porous member 6, the vacuum vessel 30, negative pressure introduction mechanism 31, and varnish providing mechanism 32 are removed from the piston base material 1′.

Thereafter, after the varnish 39 impregnated into each of pores 9a of the porous member 6 is cured, casting fins, each piston ring groove 2c, etc. which are formed on the outer peripheral surface of the piston base material 1′ are conducted to cutting. Furthermore, the crown surface 2a, the cylindrical part 2d, the projecting portion 6b of the low thermal conductivity part 5 (porous member 6) being convex shaped, etc. are conducted to cutting, thereby making them into the same surface as the upper surface of the recessed portion 2b (cutting work). By those series of molding process, the molding work of the piston 1 is to be completed.

As described above, in the present embodiment, the low thermal conductivity part 5 is provided at the part of the crown surface 2a of the piston 1 to which fuel is directly injected, wherein the low thermal conductivity part 5 is composed of the porous member 6 as a main structure, and the porous member 6 is made of borosilicate glass having a lower thermal conductivity than the aluminum alloy material. This produces an excellent thermal insulation property, and thereby promotes sufficiently atomization of the fuel, to enhance the combustion performance, and enhance the fuel efficiency.

With regard to the thermal conductivity of the low thermal conductivity part 5, as the porosity of the pores 9a of the porous member 6 decreases, the quantity of impregnation of the aluminum alloy material 1a of the piston 1 in the pores 9a decreases so that the thermal conductivity decreases because the total volume ratio of the first powder 8 (glass powder) and the residual sodium chloride powder increases.

After the residual sodium chloride appearing on the surface is dissolved and removed with water or hot water, the surface area becomes larger than the surface area constituted by the first powder 8 and the residual sodium chloride before the removal, because only the glass component of the first powder 8 is left to form irregularities after the removal.

As described above, as the thermal conductivity of the low thermal conductivity part 5 decreases, the quantity of accumulated heat in the low thermal conductivity part 5 increases, so that the accumulated heat serves to promote atomization of the fuel, and the increase of the surface area also serves to transmit heat to the fuel, and thereby promote atomization of the fuel.

Moreover, the configuration that the low thermal conductivity part 5 is impregnated through the many pores 9a with the aluminum alloy material 1a that is identical to the piston base material 1′, serves to enhance the fusion resistance between the aluminum alloy material 1a and the piston base material 1′, and thereby enhance the bond strength therebetween.

As a result, it is possible to simultaneously achieve high thermal insulation and high bond strength between the piston base material 1′ and the low thermal conductivity part 5.

In particular, the configuration that the many pores 9a of the porous member 6 are impregnated with the aluminum alloy material 1a of the piston 1, serves to increase the interface strength between the porous member 6 and the cast alloy of the piston 1.

Furthermore, in the present embodiment, as the varnish 39 is impregnated into each of pores 9a formed in the porous member 6 using the above-mentioned varnish impregnation device which is vacuum-assisted, impregnating ability of the varnish 39 to each of pores 9a can be improved. Especially, the varnish 39 is directly supplied to the upper surface 6c of the porous member 6 and impregnated into each of pores 9a by vacuum drawing and atmospheric pressure. Therefore, the impregnating effect of the varnish 39 improves.

As the result, the remaining of the pores 9a, in particular, in the upper surface 6a side of the porous member 6 can sufficiently be prevented by improving the sealing treatment. Therefore, it is possible to sufficiently prevent exhaust emission property from worsening.

### Second Embodiment

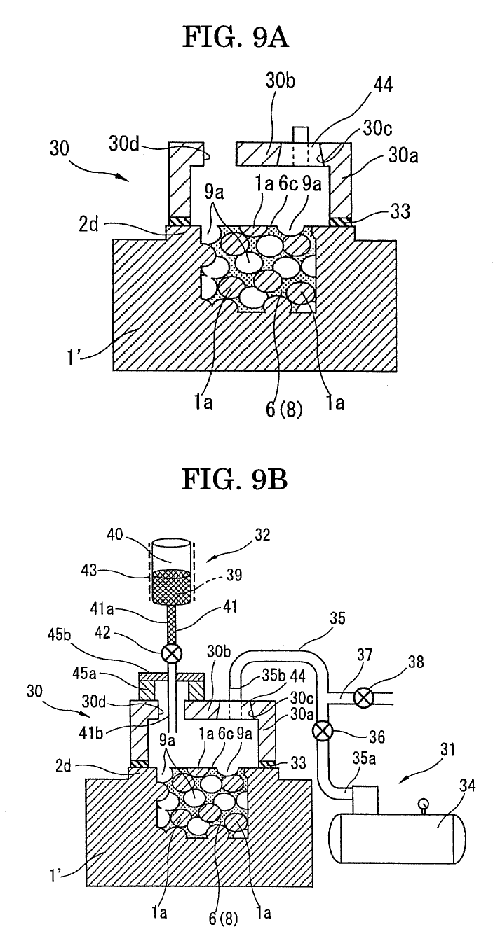

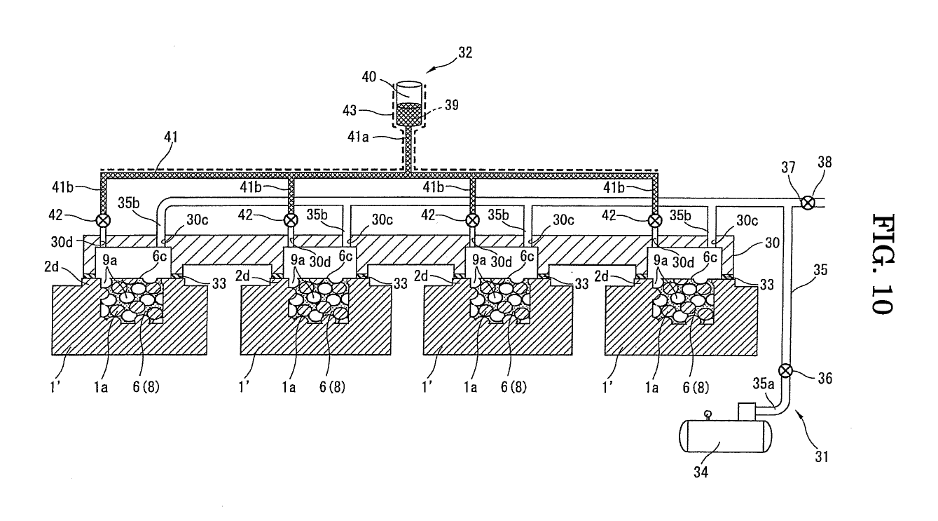

FIG. 9 shows the second embodiment. In FIG. 9, a pipe connecting connector 44 is installed in advance in the first fixing hole 30c formed on the upper wall part 30b of the vacuum vessel 30. On the other hand, a support member 45a and a support piece 45b are disposed on an upper part of a hole edge of the second fixing hole 30d. The support member 45a is cylindrical. The support piece 45b is mounted and fixed on an upper end surface of the support member 45a, and in its center, a support hole where a lower end part of the varnish providing pipe 41 inserted and supported is installed. Furthermore, the support member 45a and the support piece 45b liquidtightly contact the vacuum vessel 30 by a predetermined sealing member, and a gap between the hole edge of the support hole and a lower end part of the varnish providing pipe 41 is also sealed.

Therefore, in order to connect the vacuum vessel 30 with the negative pressure introduction mechanism 31 and the varnish providing mechanism 32, as shown in FIG. 9B, the connector 44 installed on the first fixing hole 30c in advance is connected with the other end part 35b of the vacuum pipe 35. Furthermore, the support part 45a where the support piece 45b is fixed is mounted and fixed on an upper part of the second fixing hole 30d, and the tip part of the lower end part of the varnish providing pipe 41 is faced to the inside of the vacuum vessel 30 while inserting the lower end part into the support hole of the support piece 45b. Thereby, the connection of the mechanisms 31 and 32 to the vacuum vessel 30 is completed.

In this connection state, each of pores 9a of the porous member 6 is filled (impregnated) with the varnish 39 by the same processes as the above-mentioned filling and impregnating processes of the varnish. Therefore, the same effects as in the first embodiment can be obtained.

Furthermore, after having completed the impregnation work of the varnish 39, the negative pressure introduction mechanism 31 and the varnish providing mechanism 32 are removed from the vacuum vessel 30. Thereafter, the vacuum vessel 30 is removed from the cylindrical part 2d. In this way, as each of mechanisms 31 and 32 is removed from the vacuum vessel 30, the varnish 39 never run out to a surrounding area.

### Third Embodiment

FIG. 10 shows the third embodiment. In the first and second embodiments, the varnish impregnation device is connected with individual piston base material 1′. However, in this embodiment, four vacuum vessels 30 integrally combined in advance are simultaneously mounted and fixed on upper surfaces of each cylindrical part 2d of four piston base materials 1′ arranged in parallel. Furthermore, the first fixing holes 30c of each vacuum vessel 30 are connected with the other end parts 35b of the vacuum pipe 35, which is branched into four branches, of the negative pressure introduction mechanism 31; and the lower end parts 41b of the varnish providing pipe 41, which is branched into four branches, of the varnish providing mechanism 32.

Therefore, according to this embodiment, as its basic configuration is the same as the first and second embodiments, the same effects can be obtained. Especially, it is possible to conduct vacuum drawing, provision of varnish 39, etc. at the same time to each porous member 6 of the four piston base materials 1′, so working efficiency of the sealing treatment can be improved.

The present invention is not limited to the structures of each embodiment. For example, a lot of piston base materials 1′ are continuously arranged on the manufacturing line, and the vacuum vessels 30 are mounted and fixed in succession on the cylindrical parts 2d of each piston base material 1′, and continuous sealing treatments can be conducted.

Furthermore, in the present embodiments, a materials including polyimide or polyamide imide, which are organic resin materials, has been used as a sealing agent (impregnant). However, it may be what is capable of enduring under thermal environment of the crown surface 2a of the piston 1. For example, sodium silicate, which is inorganic material, alkyl silicate, organosiloxane, dichromate, etc. may be used.

1. A piston for internal combustion engine, where a low thermal conductivity part which is lower in thermal conductivity than a piston base material is provided at a predetermined location of a crown surface,
the low thermal conductivity part comprising:
a porous member having thermal conductivity lower than the thermal conductivity of the piston base material and
an impregnant with which pores of the porous member is impregnated,
wherein the impregnant is held in the pores under usage environment of the piston during driving of the engine.

2. The piston for internal combustion engine as claimed in claim 1, wherein the impregnant is formed of a resin-based material.

3. The piston for internal combustion engine as claimed in claim 2, wherein the resin-based material has a glass transition temperature being 350° C. or higher.

4. The piston for internal combustion engine as claimed in claim 3, wherein the resin-based material includes polyimide or polyamide imide.

5. The piston for internal combustion engine as claimed in claim 1, wherein the porous member is formed of a glass material as a base material and impregnated with a part of the piston base material, and wherein the impregnant is impregnated into the pores formed by dissolving a material which is water-soluble and has a melting point higher than the melting point of the glass material between the glass material and the piston base material.

6. The piston for internal combustion engine as claimed in claim 5, wherein the porous member is a borosilicate glass.

7. The piston for internal combustion engine as claimed in claim 5, wherein the piston base material is an aluminum alloy material.

8. The piston for internal combustion engine as claimed in claim 5, wherein the material which is water-soluble and has a melting point higher than the melting point of the glass material is sodium chloride.

9. The piston for internal combustion engine as claimed in claim 1, wherein the impregnant is an inorganic material.

10. A process for producing a piston for internal combustion engine where a low thermal conductivity part which is lower in thermal conductivity than a piston base material is provided at a predetermined location of a crown surface,
the process comprising:
a first step of depressurizing a predetermined area including a surface of the porous member having thermal conductivity lower than thermal conductivity of the piston base material after the low thermal conductivity part is integrally molded in the crown surface of the piston base material,
a second step of impregnating an impregnant into a plurality of pores of the porous member during the depressurizing of the first step, and
a third step where the predetermined area is opened to atmosphere after the second step, and filling of the impregnant impregnated into the plurality of pores is conducted by atmospheric pressure.

11. The process for producing the piston for internal combustion engine as claimed in claim 10, wherein the impregnant is a varnish including polyimide or polyamide imide.

12. The process for producing the piston for internal combustion engine as claimed in claim 11, wherein the process comprises a fourth step of evaporating a solvent by heating the predetermined area after the third step to be made into a solid component.

13. The process for producing the piston for internal combustion engine as claimed in claim 12, wherein heating treatment temperature in the fourth step is 100-150° C.

14. The process for producing the piston for internal combustion engine as claimed in claim 13, wherein a time of heating treatment is 30-60 minutes.

15. The process for producing the piston for internal combustion engine as claimed in claim 14, wherein the heating treatment is conducted at 130° C. for 30 minutes.

16. The process for producing the piston for internal combustion engine as claimed in claim 10,
the process comprising previous steps of the first step,
the previous steps comprising:
a mixing step of generating a mixed powder by mixing and stirring a first powder and a second powder, the first powder having a thermal conductivity lower than the thermal conductivity of the piston base material and being softened by heat, the second powder being water-soluble and having a melting point higher than the melting point of the first powder,
a burning step of burning the mixed powder after subjected to pressure molding,
a dissolving step of dissolving the second powder with a liquid to form the porous member after the burning step,
an injecting step of injecting a molten metal into a mold to mold a piston after disposing the porous member in the mold while sucking the porous member or pressurizing the molten metal, and of impregnating the piston base material into the plurality of the pores of the porous member, and
a cutting step of cutting the crown surface of the piston cooled and thereafter taken out from the mold.

17. The process for producing the piston for internal combustion engine as claimed in claim 16, wherein the first powder is a borosilicate glass, and the second powder is sodium chloride.

18. A device for producing a piston for internal combustion engine where a low thermal conductivity part which is lower in thermal conductivity than a piston base material is provided at a predetermined location of a crown surface,
the device comprising:
a cup-shaped member covering an area including a surface of a porous member forming the low thermal conductivity of the crown surface;
a negative pressure introduction mechanism including:
a negative pressure introduction passage whose one end part is connected with the cup-shaped member,
a first switching valve being disposed in the negative pressure introduction passage and opening and closing the negative pressure introduction passage, and
a negative pressure generator disposed in the other end part of the negative pressure introduction passage;
an impregnant providing mechanism including:
an impregnant introduction passage whose one end part is connected with the cup-shaped member,
a second switching valve being disposed in the impregnant introduction passage and opening and closing the impregnant introduction passage, and
a storage tank being disposed in the other end part of the impregnant introduction passage and storing the impregnant therein; and
a third switching valve being disposed in an atmospheric pressure introduction passage connected with the cup-shaped member and introducing an atmospheric pressure into the cup-shaped member or blocking the introduction.
